(19) United States
(12) Patent Application Publication
(10) Pub. No.: US 2005/0112050 A1
(43) Pub. Date: May 26, 2005

(54) Process to reduce the pre-reduction step for catalysts for nanocarbon synthesis

(76) Inventor: Bhabendra K. Pradhan, Marietta, GA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(21) Appl. No.: 10/719,923

(22) Filed: Nov. 21, 2003

(51) Int. Cl. B01J 23/00; D01F 9/12; D01C 5/00; B01J 23/70; B01J 23/74; B01J 23/72

(52) U.S. Cl. 423/447.1; 502/300; 502/338; 502/345; 502/337; 502/321

(57) ABSTRACT

A process to eliminate or reduce the pre-reduction step for catalysts for nano-carbon synthesis by first, heating a metal oxide at 5° C./min to 350-500° C. for 70-90 minutes under 10-20% hydrogen; optionally holding the temperature for 10 to 60 minutes; then initiating carbonaceous feedstock flow.

### CROSS-REFERENCE TO RELATED APPLICATIONS

Not applicable

### REFERENCE TO A “MICROFICHE APPENDIX”

Not applicable

### BACKGROUND OF THE INVENTION

1. Field of the Invention

The present invention relates to nano-carbon synthesis. More particularly the present invention relates a process to reduce the pre-reduction step for catalysts for nano-carbon synthesis by approximately 90% of the conventional process time.

2. General Background of the Invention

In synthesizing carbon nanofibers, in the conventional manner as taught by the prior art, there is a catalyst pre-reduction requirement involved followed by passivation, which provides a thin metal oxide cover over the metal core. This time consuming step usually takes more than 24 hours. In this conventional process, the first step is reduction of the metal oxide under 10-20% H₂ at 400-600° C. for 20 hours, followed by passivation at room temperature for another hour under 2% O₂.

Reference is made first to a publication by R. T. Baker, et al., entitled “Growth of Graphite Nanofibers from the Iron-Copper Catalyzed Decomposition of CO/H₂ Mixtures,” where it is disclosed how catalysts for nano-carbon synthesis are conventionally prepared. The preparation as taught by the prior art entails reduction of metal oxide in 10% hydrogen for 20 hours at 400-600° C., preferably 450-550° C., followed by passivation in the presence of a small amount (e.g. 2%) of oxygen at room temperature, followed then by a shorter secondary reduction in 10% hydrogen at reaction temperature just prior to introduction of the carbonaceous feedstock to initiate the nano-carbon synthesis. This time frame is depicted in FIG. 1, labeled as “Prior Art.” The aforementioned Baker publication, together with U.S. Pat. No. 6,159,538, which supports the Baker publication, are provided as part of the Information Disclosure Statement submitted herewith.

### BRIEF SUMMARY OF THE INVENTION

The process of the present invention solves the problems confronted in the art in a straightforward manner. What is provided here, is a process to reduce the pre-reduction step for catalysts for nano-carbon synthesis by first, heating a metal oxide at 5° C./min to 350-500° C. over 70-90 minutes under 10-20% hydrogen to affect its reduction; optionally holding the temperature for 10 to 60 minutes; then initiating carbonaceous feedstock flow.

Accordingly, it is an object of the present invention to provide a method for reducing the pre-reduction step for catalysts for nano-carbon synthesis;

It is a further object of the present invention to provide a method to reduce the pre-reduction step for catalysts for nano-carbon synthesis from 20 hours in the conventional process down to one hour;

It is a further object of the present invention to provide a method to reduce the pre-reduction step for catalysts for nano-carbon synthesis by ≧90% of the time involved in the conventional method;

It is a further object of the present invention to reduce the pre-reduction step for catalysts for nano-carbon synthesis which provides the possibility of continuous catalyst preparation and nano-carbon synthesis;

It is a further object of the present invention to provide a method to the pre-reduction step for catalysts for nano-carbon synthesis which renders scale-up of nano-carbon synthesis easier.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates a graph of the conventional prior art method of producing catalysts for nano-carbon synthesis;

FIG. 2 is a transmission electron micrograph of the morphology of the nano-carbon fibers produced in the conventional prior art method depicted in FIG. 1;

FIG. 3 illustrates a graph of the preferred embodiment of method of the present invention of producing catalysts for nano-carbon synthesis; and

FIG. 4 is a transmission electron micrograph of the morphology of the nano-carbon fibers produced in the preferred embodiment of the method of the present invention depicted in FIG. 3.

### DETAILED DESCRIPTION OF THE PREFERRED EMBODIMENTS

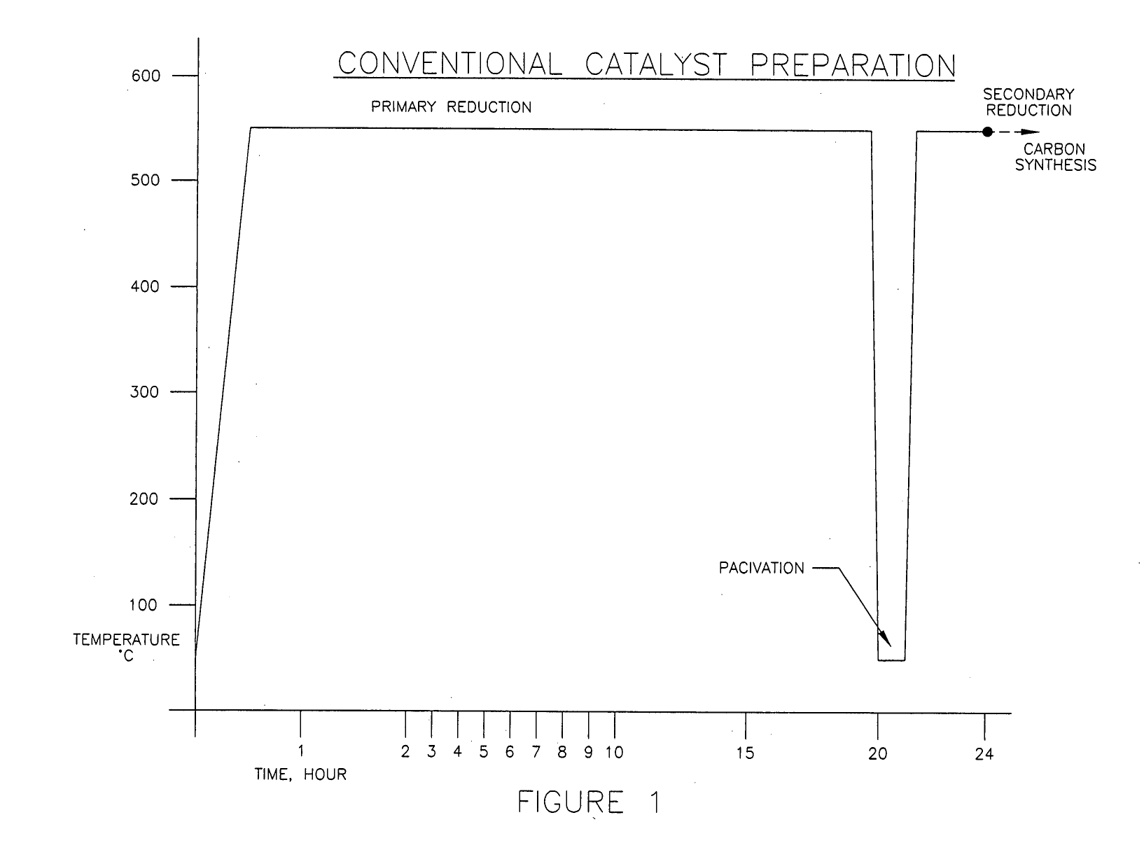

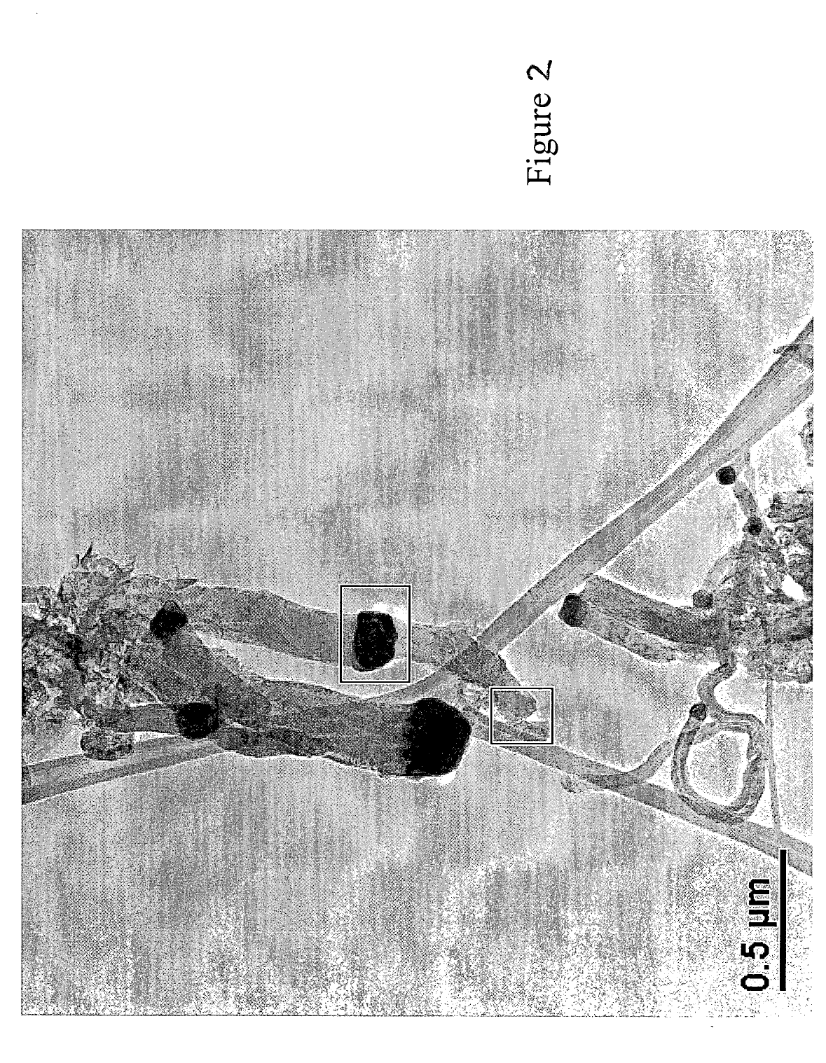

Turning now to the Figures, FIG. 1 illustrates a graph of the conventional prior art method of producing catalyst for use in nano-carbon fiber production, while FIG. 2 is a transmission electron micrograph of the morphology of the nano-carbon fibers produced in the conventional prior art method depicted in FIG. 1.

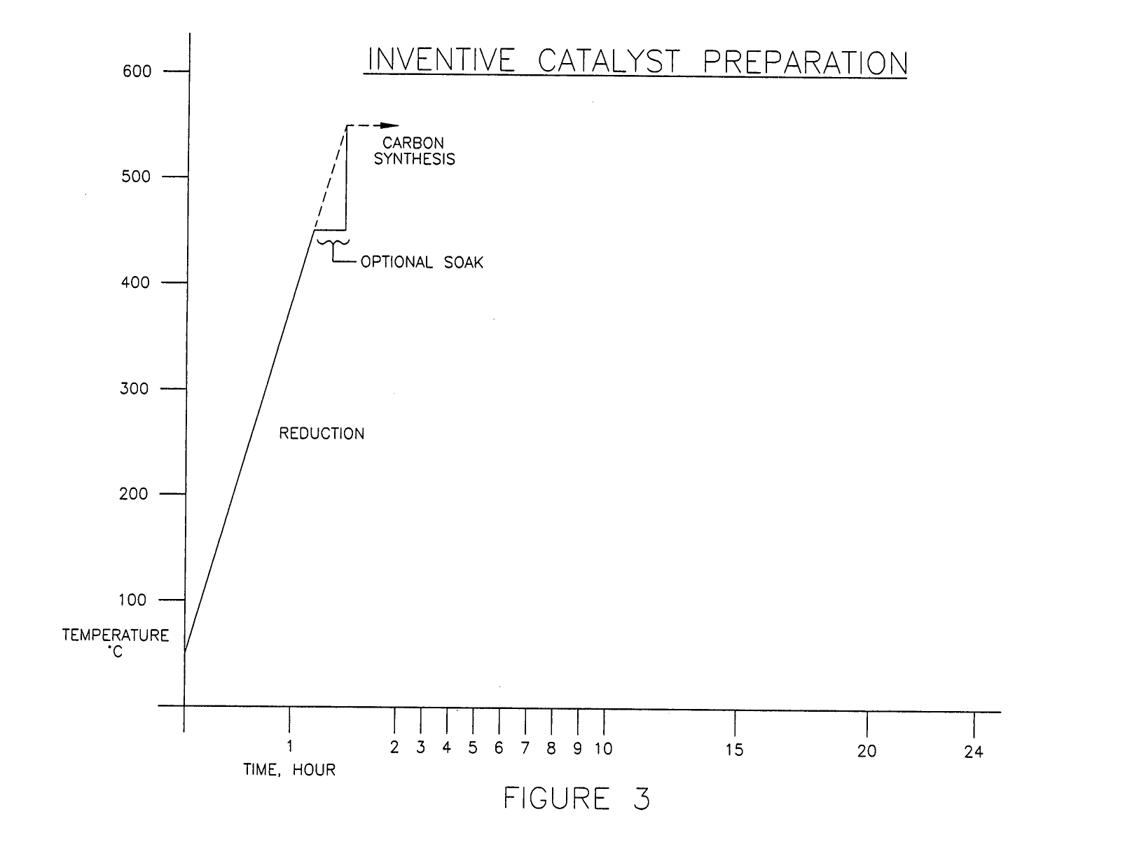

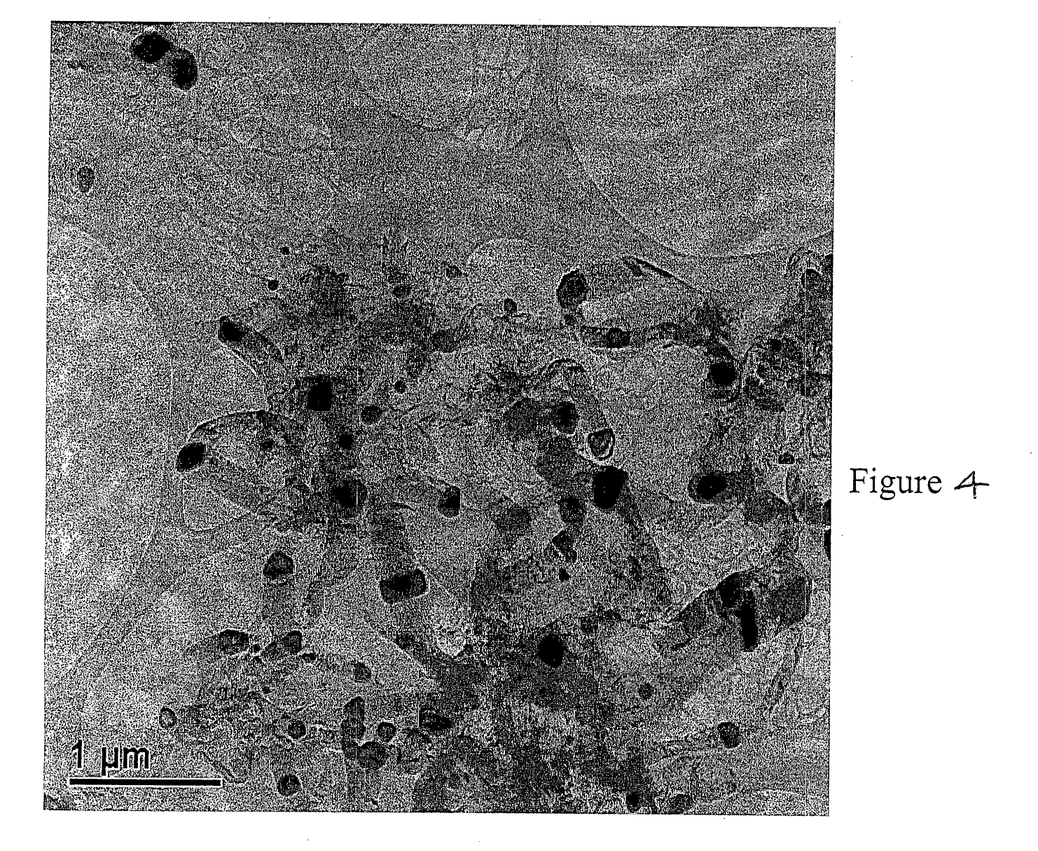

FIG. 3 illustrates the preferred method of the process to reduce the prereduction steps for catalysts in nano-carbon synthesis, while FIG. 4 is a transmission electron micrograph of the morphology of the nano-carbon fibers produced in the preferred embodiment of the method of the present invention depicted in FIG. 3.

However, before a discussion of the method of the preferred embodiment of the present invention, reference is made to FIGS. 1 and 2. In FIG. 1, there is depicted a graph of the conventional metal oxide catalyst preparation plotting the Temperature vs. Time. As illustrated, the primary reduction of the catalyst is initiated at approximately 50° C. As seen in FIG. 1, the temperature of the catalyst is raised to between 500-600° C., so that over a period of some twenty hours the reduction takes place at that constant temperature. At the end of the primary reduction phase, the passivation step is initiated where the catalyst is cooled to a temperature of around 50° C. or below, under a flow of 2% oxygen, for a period of approximately one hour. Finally, secondary reduction takes place, where the catalyst temperature is returned to between 500-600° C., under a flow of 10% hydrogen, at which point the carbon nano-fiber synthesis is initiated. As can be seen clearly from this graph the entire process of preparing the catalyst under the conventional manner takes over twenty some hours in order to complete.

FIG. 2 is a transmission electron micrograph of the morphology of the carbon nano-fibers produced from the conventional catalyst preparation as described in regard to FIG. 1. The carbon production rate was approximately 2.40 g Carbon/g catalyst/hr.

Turning now to the method of the preferred embodiment of the present invention reference is first made to FIG. 3, which illustrates the preferred method of the process to reduce the prereduction steps for catalysts in nano-carbon synthesis. As illustrated, the metal oxide catalyst is brought from a temperature of around 50° C. to a temperature of between 400-500° C. in approximately one hours time under 10-20% hydrogen. At this point there is a brief optional dwell time. The metal oxide catalyst temperature is increased from 400-500° C. to between 500-600° C. and a mixture of CO/H₂ in a ratio 1:4 to 4:1 by volume is then passed thereover to initiate the carbon nano-fiber synthesis. As seen in FIG. 3, the entire catalyst preparation process takes place over a period of less than 2 hours. It is clear in comparing the present invention with the conventional catalyst preparation, that the time has been reduced from some twenty plus hours to a period of at least less than two hours.

FIG. 4 is a transmission electron micrograph of the morphology of the nano-carbon fibers produced in the preferred embodiment of the method of the present invention depicted in FIG. 3. The carbon production rate was approximately 2.56 g Carbon/gcatalyst/hr.

The catalyst, which would consist of a metal oxide which would include, but not be limited to the oxides of iron, copper, nickle, molybdenum and combinations thereof, would be heated under 10-20% H₂ at a heating rate of 5°C. per minute to between 350-500° C. The heating of the metal oxide to this temperature would require somewhere in the neighborhood of 70-90 minutes. The system would then be ramped to the reaction temperature under nitrogen gas. There would be a change to reaction gas to commence carbon nano-fiber synthesis.

Example 1, discussed below, relates to the production of catalysts under the conventional prior art process. Example 2, also discussed below, relates to the process of the present invention. In both Examples 1 and 2 the production of carbon nano-fibers have approximately essentially equivalent production rates for the two catalysts. It is clear that if the catalyst preparation time is reduced as taught in the present invention, development of a process for the continuous production of carbon nano-fibers, will be facilitated.

### EXAMPLE 1

Example 1 is the conventional prior art catalyst preparation, as shown in FIG. 1. In this example, a mixture comprising of 0.1 grams of iron and copper oxides containing 98:2 weight ratio of Fe/Cu was placed in a tubular reactor and reduced at 600° C. for 20 hours and 10% hydrogen (balance nitrogen), cooled to room temperature, passivated for one hour utilizing 2% oxygen (balance nitrogen), then reheated to 600° C. under 10% hydrogen (balance nitrogen) for two hours. A mixture of CO/H₂ (1:4 by volume) was then passed thereover at a rate of 200 sccm to produce carbon nano-fibers as depicted in the transmission electron micrograph of FIG. 3. Carbon production rate was 2.40 grams carbon/grams catalyst per hour.

The present invention will be illustrated in more detail with reference to the following Example 2, which should not be construed to be limiting in scope of the present invention.

### EXAMPLE 2

Example 2 is the preferred embodiment of the process of the present invention, as shown in FIG. 2. In this example, the catalyst preparation included a mixture comprising of 0.1 gram of iron and copper oxides containing 98:2 weight ratio of Fe/Cu was placed in a tubular reactor, heated at a rate of 5° C. per minute to 500° C. under 10% hydrogen (balance nitrogen) and held there for thirty minutes. The temperature was increased to 600° C. and a mixture of CO/H₂ (1:4 by volume) was then passed thereover at a rate of 200 sccm to produce carbon nano-fibers as depicted in the transmission electron micrograph of FIG. 4. The entire catalyst preparation process takes less than two hours, and Carbon production rate was 2.56 grams of carbon per gram of catalyst per hour.

It should be noted that in both Examples 1 and 2, the carbon production rates are essentially equivalent for the two catalysts. Furthermore, the morphology of the carbons produced in Examples 1 and 2 are identical as shown in FIGS. 2 and 4. The magnification of FIG. 4 is reduced only to show a larger field of product. The background “web” in the micrographs is the support grid. It should be noted that the inventive catalyst preparation taught herein is applicable to other catalysts used to produced nano-carbons of various morphology; and these may include, but are not limited to the oxides of iron, copper, nickel, molybdenum and combinations thereof.

The foregoing embodiments are presented by way of example only; the scope of the present invention is to be limited only by the following claims.

1. A method of preparing and utilizing a catalyst for nano-fiber synthesis, comprising the following steps:
a. heating a metal oxide to an initial temperature of between 400 and 500° C. in 10-20% hydrogen at a heating rate of 1-10° C./min to affect its reduction and holding for around 10-60 minutes;
b. increasing the temperature to between 550-700° C.; and
c. passing a mixture of CO/H2 over the catalyst to produce the nano-carbon fibers.

2. The method in claim 1, wherein the metal oxide comprises iron oxide.

3. The method in claim 1, wherein the metal oxide comprises a mixture of iron and copper oxides.

4. The method in claim 3, wherein the mixture of iron and copper oxides contains a 99:1 to 50:50 weight ratio of Fe to Cu.

5. The method in claim 1, wherein the metal oxides are selected from a group consisting of oxides of iron, copper, nickel, molybdenum and combinations thereof.

6. The method in claim 1, wherein the heating time in step (a) is less than 60 minutes.

7. The method in claim 1, wherein steps a and b are performed in less than two hours time.

8. The method in claim 1, wherein the mixture of CO/H2 is provided at 1:4 to 4:1 by volume.

9. The method in claim 1, wherein the mixture of CO/H2 is provided at 1:4 by volume.

10. The method in claim 1, wherein the carbon production rate equals or exceeds 2.5 Carbon/g catalyst/hr.

11. The method in claim 1, wherein the method comprises a continuous method for producing catalyst and carbon nano-fibers by reducing the pre-reduction time ofthe catalyst.

12. The method in claim 1, wherein the hydrogen is balanced by an inert gas.

13. A method of producing and utilizing a catalyst for nano-fiber synthesis, comprising the following steps:
a. heating a metal oxide catalyst to an initial temperature of between 400 and 500° C. in 10% hydrogen at a heating rate of 5° C./min to affect its reduction and holding for less than 60 minutes;
b. increasing the temperature to at least 550 oc;
c. passing a mixture of CO/H2 over the catalyst to produce nano-carbon fibers.

14. The method in claim 13 wherein the mixture of CO/H2 is provided at 1:4 by volume.

15. The process in claim 13, wherein carbonaceous feedstock flow to produce nano-fibers begins within one hour from when the metal oxide catalyst is brought to its initial temperature of between 400 and 500° C.

16. A method of producing and utilizing a catalyst for nano-fiber synthesis, comprising the following steps:
a. heating a metal oxide catalyst to an initial temperature of between 400 and 500° C. in 10-20% hydrogen at a heating rate of 5° C./min to affect its reduction and holding for around 10-60 minutes;
b. increasing the temperature to at least 550° C. but no higher than 700° C.;
c. passing a mixture of CO/H2 over the catalyst to produce nano-carbon fibers.

17. The method in claim 16, wherein the method comprises a continuous method of producing the catalyst for nano-fiber synthesis.

18. A method of preparing a catalyst for nano-fiber synthesis, comprising the following steps:
a. heating a metal oxide to an initial temperature of between 400 and 500° C. in 10-20% hydrogen at a heating rate of 1-10° C./min to affect its reduction and holding for around 10-60 minutes; and
b. increasing the temperature of the catalyst to between 550-700° C. for use as a catalyst in producing nano-fiber synthesis.

19. A method of producing a catalyst for nano-fiber synthesis, comprising the following steps:
a. heating a metal oxide catalyst to an initial temperature of between 400 and 500° C. in 10% hydrogen at a heating rate of 5° C./min to affect its reduction and holding for less than 60 minutes; and
b. increasing the temperature of the catalyst to at least 550° C. for use in producing nano-carbon fibers.

20. A method of producing a catalyst for nano-fiber synthesis, comprising the following steps:
a. heating a metal oxide catalyst to an initial temperature of between 400 and 500° C. in 10-20% hydrogen at a heating rate of 5° C./min to affect its reduction and holding for around 10-60 minutes; and
b. increasing the temperature of the catalyst to at least 550° C. but no higher than 700° C. so that the catalyst can be used to produce nano-carbon fibers.

21. (canceled)

22. The method of claim 18, wherein a mixture of CO/H2 is passed over the catalyst to produce nano-carbon fibers.

23. The method in claim 19, wherein a mixture of CO/H2 is passed over the catalyst to produce nano-carbon fibers.

24. The method of claim 20, wherein a mixture of CO/H2 is passed over the catalyst to produce nano-carbon fibers.
